(19) United States
(12) Patent Application Publication
(10) Pub. No.: US 2005/0238887 A1
(43) Pub. Date: Oct. 27, 2005

(54) Infrared reflecting multiple layer glass panels

(76) Inventor: John Joseph D'Errico, Glastonbury, CT (US)

Correspondence Address: BRENC LAW, 47 BANKS ROAD, SIMSBURY, CT, 06070, US

(21) Appl. No.: 10/832,450

(22) Filed: Apr. 27, 2004

(51) Int. Cl. B32B 27/42

(52) U.S. Cl. 428/432; 428/441

(57) ABSTRACT

The present invention is in the field of laminated glass comprising an infrared reflecting layer and a polymer sheet and methods of producing and using the same, and more specifically, the present invention is in the field of laminated glass comprising an infrared reflecting layer and a layer comprising a poly(vinyl butyral) sheet having a low glass transition temperature and methods of producing and using the same.

### FIELD OF THE INVENTION

The present invention is in the field of laminated glass comprising an infrared reflecting layer and a polymer sheet and methods of producing and using the same, and more specifically, the present invention is in the field of laminated glass comprising an infrared reflecting layer and a layer comprising a poly(vinyl butyral) sheet having a low glass transition temperature and methods of producing and using the same.

### BACKGROUND

Windows containing metal/dielectric stacks to reflect infrared radiation while transmitting significant visible light are well known. These windows have the effect of reducing temperature buildup from solar radiation within an area delimited by one or more of such windows. These stacks are called interference filters and can comprise at least one layer of reflective metal sandwiched between reflection-suppressing or anti-reflective dielectric layers. It is likewise known to heat the metal layer by electrical conductance to provide defrost or deice and/or defog capability.

Representative structures for motor vehicle windshields are disclosed in International Publication W0 88/1230 and U.S. Pat. No. 4,799,745. Such solar screening and/or electrically conductive layered assemblies are referred to in abbreviated form hereinafter as “IR reflective coating”.

When IR reflective coatings are combined with glass in laminated glass panels, particularly in vehicle windshields, it is often desirable to include a plasticized energy-absorbing interlayer which contains poly(vinyl butyral) (PVB) in the assembly to absorb a blow, for example from the head of an occupant, from within the vehicle without penetrating the laminate. In such laminated assemblies, the poly(vinyl butyral) layer is generally in contact with the top layer of the IR reflective coating.

Unfortunately, after extended periods of use, the strength of the bond between the IR reflective coating and poly(vinyl butyral) layer in laminated glass panels can weaken. One way to improve the long term stability of this bond is by using special cap layers in the IR reflective coating chosen for their ability to adhere well to the poly(vinyl butyral) layer. Such cap layers promote adhesion to the poly(vinyl butyral) layer and usually do not otherwise function in the optical performance of the IR reflective coating.

Further improvements in long term stability of the IR reflective coating and the poly(vinyl butyral) layer are desirable. Accordingly, further improved compositions and methods are needed to enhance the characteristics of laminated glass that incorporates a metallic infrared reflecting layer.

### SUMMARY OF THE INVENTION

The present invention is in the field of laminated glass comprising an infrared reflecting layer and a polymer sheet and methods of producing and using the same, and more specifically, the present invention is in the field of laminated glass comprising an infrared reflecting layer and a layer comprising a poly(vinyl butyral) sheet having a low glass transition temperature and methods of producing and using the same.

The present invention includes a laminated glass panel, comprising: a glass layer; an infrared reflective layer disposed in contact with said glass layer; and, a polymer layer disposed in contact with said infrared reflective layer, wherein said polymer layer has a glass transition temperature of 23° C. or less.

The present invention includes a laminated glass panel, comprising: a first glass layer; an infrared reflective layer disposed in contact with said first glass layer; a polymer layer disposed in contact with said infrared reflective layer, wherein said polymer layer comprises poly(vinyl butyral) and has a glass transition temperature of 23° C. or less; and, a second glass layer disposed in contact with said polymer layer.

The present invention includes a method of reducing infrared electromagnetic radiation through an opening, comprising: disposing a panel of laminated glass in said opening, wherein said panel of laminated glass comprises: a glass layer; an infrared reflective layer disposed in contact with said glass layer; and, a polymer layer disposed in contact with said infrared reflective layer, wherein said polymer layer has a glass transition temperature of 23° C. or less.

The present invention includes a laminated glass panel, comprising: a glass layer; a layer of poly(vinyl butyral) disposed in contact with said glass layer, wherein said layer of poly(vinyl butyral) has a glass transition temperature of 23° C. or less; an infrared reflective layer disposed in contact with said layer of poly(vinyl butyral); and, a layer of polyethylene terephthalate or polyethylene napthalate disposed in contact with said infrared reflective layer.

### DETAILED DESCRIPTION

The present invention is in the field of laminated glass comprising an infrared reflecting layer and a polymer sheet and methods of producing and using the same, and more specifically, the present invention is in the field of laminated glass comprising an infrared reflecting layer and a layer comprising a poly(vinyl butyral) sheet having a low glass transition temperature and methods of producing and using the same.

According to the present invention, it has surprisingly been discovered that multiple layer glass panels comprising a low glass transition temperature polymer layer disposed in contact with an infrared reflecting layer have improved long term stability.

Laminated glass structures that are capable of reflecting infrared radiation have been described. For example, U.S. Pat. No. 5,427,861 describes the use of various types of infrared reflective layers. According to the present invention, it has surprisingly been discovered that polymer sheets, or layers, that have a low glass transition temperature (T_{g}) provide improved adhesion to infrared reflective layers over time. This result allows the fabrication of improved laminated glass panels that resist the degradation of adhesion characteristics over time due to exposure to light.

In various embodiments, the present invention includes a laminated glass panel, comprising: a glass layer; an infrared reflective layer disposed in contact with said glass layer; and, a polymer layer disposed in contact with said infrared reflective layer, wherein said polymer layer has a glass transition temperature of 23° C. or less. Of course other embodiments having additional glass and polymer layers are included within the scope of the present invention. In various embodiments, laminated glass panels of the present invention comprise four layers: glass/infrared reflective layer/polymeric layer/glass.

As used herein, a “laminated glass panel” is any structure that incorporates a layer of glass and a layer of polymeric material into a single finished multiple layered glass product, for example, and without limitation, automobile, aircraft, and locomotive windshields and glass, and architectural glass applications, for example outside windows and internal glass structures.

In one embodiment, an infrared reflective layer is disposed in contact with a glass layer. The infrared reflective layer can comprise multiple layers of different materials, for example in a metal/dielectric stack. The infrared reflective layer can be any layer as is known in the art to function to reflect infrared radiation in laminated glass applications, and can be applied to the glass layer by any known method, such as magnetron sputtered.

The metal/dielectric stack component can be, for example, an interference filter of the Fabry-Perot type design, and can be tailored to any particular application through the appropriate selection of materials and their thicknesses to, in various embodiments, maximize transmission of visible light and to maximize reflection of heat-generating infrared portions (700-2125 nm) of the solar spectrum. Such stacks can consist of multiple, sequentially deposited planar layers of angstroms-thick metal and dielectric coatings arranged in a predetermined sequence in face-adhering, contiguous contact with each other, as is generally disclosed in U.S. Pat. Nos. 3,682,528 and 4,179,181.

In one embodiment, the infrared reflective layer comprises a dielectric stack comprising one or more near IR reflecting metal layers, which, in operative position, transmit at least 70% visible light of normal incidence measured as specified in ANSI Z26.1. A lower level of transmission is acceptable in less demanding architectural applications where a single metal layer or other more light absorbing metal/dielectric stacks may be used.

In various embodiments, visible light reflectance normal from the surface of the stack is less than about 10%, 8%, 6%, or 5%. The metal layers(s) are typically separated (i.e. vertically in the thickness direction) from each other by one or more dielectric layers so reflection of visible light from the metal layer(s) interferes destructively, thereby enhancing visible transmission. Usable metals include silver, aluminum, chromium, zinc, tin, nickel, brass, gold, stainless steel, copper, and alloys or claddings of any of the foregoing. In various embodiments, the metal is silver. Metal layer thickness can be between, for example, 40 Å to 250 Å, 60 Å to 200 Å, 70 Å to 175 Å, 80 to 140 Å, and 60 Å to 200 Å.

The dielectric layer element can be essentially transparent over the visible range and, in various embodiments, one dielectric layer is disposed in contact with and between a pair of metal layers. In various embodiments, dielectric layers are disposed on each side of a metal layer. Exemplary usable dielectric materials include WO₃, In₂O₃, SnO₂, ITO, AL₂O₃, MgF₂, ZnS, TiO₂, and ZnO.

Various cap layers can be used in the infrared reflective layers of the present invention. As used herein, a “cap” layer is the layer that is disposed in contact with the polymeric layer, such as poly(vinyl butyral).

In various embodiments, a cap layer of chromium oxide, CrₓO_{y} where x is 1 or 2 and y is between 1 and 5, inclusive of 1 and 5, is the top layer of the metal/dielectric stack in contact on one side with the plasticized poly(vinyl butyral) layer and on the other side with an anti-reflective layer of the metal/dielectric stack. The values of x and y in these embodiments can vary depending on the amount of oxidation occurring during deposition of this cap layer and the intended use of the finished product. The oxidation is determined by the sputtering conditions used, including deposition rate, the power level used, and the percentage of oxygen in the sputtering chamber of an admixture of oxygen and another gas such as argon. The values of x and y or the oxidation state for any given set of deposition conditions can be determined by known ESCA (XPS) or AES analyses. In various embodiments, silicon nitride can be used as the cap layer. Any combination of the metals and dielectric layers, as well as silicon nitride, can be used in an infrared reflective layer of the present invention. The cap layer can also be any of the dielectric materials listed previously for dielectric layers.

Any of the embodiments of infrared reflective layers disclosed in U.S. Pat. No. 5,427,861 can be used. In various embodiments, the metal layers of the infrared reflective layer can be conductively associated with a source of electrical power in order to provide a means of heating the glass for various purposes, including, for example, for defrosting or defogging applications.

As used herein, a “polymer sheet” or “polymer layer” means any polymer composition formed by any suitable method into a thin layer that is suitable for use as an interlayer in laminated glass structures.

The polymer sheet that is disposed in contact with the cap layer can comprise any suitable polymer that has a glass transition temperature of 23° C. or less, and, in a preferred embodiment, as exemplified above, the polymer sheet comprises poly(vinyl butyral). In any of the embodiments of the present invention given herein that comprise poly(vinyl butyral), another embodiment is included in which the polymer consists of or consists essentially of poly(vinyl butyral). In these embodiments, any of the variations in additives disclosed herein can be used with the polymer sheet having a polymer consisting of or consisting essentially of poly(vinyl butyral) and those additives.

In various embodiments of the present invention, the polymer layer, and specifically a poly(vinyl butyral) layer, has a glass transition temperature of 23° C. or less, less than 20° C., less than 19° C., less than 18° C., less than 17° C., less than 16° C. less than 15° C., less than 14° C., less than 13° C., less than 12° C., less than 11° C., or less than 10° C.

In various embodiments of polymer sheets of the present invention, the polymer sheets can comprise 10 to 90, 15 to 85, 20 to 60, 25 to 60, 20 to 80, 25 to 70, and 25 to 60 parts plasticizer per one hundred parts of resin (“phr”). Of course other quantities can be used as is appropriate for the particular application. The poly(vinyl butyral) sheet preferably comprises 20 to 80, and more preferably 25 to 60, parts plasticizer per one hundred parts of resin. In some embodiments, the plasticizer has a hydrocarbon segment of less than 20, less than 15, less than 12, or less than 10 carbon atoms. The amount of plasticizer can be adjusted to affect the glass transition temperature of the poly(vinyl butyral) sheet. In general, higher amounts of plasticizer are added to decrease the T_{g}. In various embodiments of the present invention, the polymer sheet comprises at least 40, at least 50, at least 60, at least 70, at least 80, at least 90,or at least 100 parts plasticizer per one hundred parts resin.

Various adhesion control agents can be used in the polymer layers of the present invention, as are known in the art, and can include, for example, potassium acetate, sodium acetate, or a magnesium salt. Examples of adhesion control agents that can be used in polymer layers of the present invention include, for example, those disclosed in U.S. Pat. No. 5,728,472.

In embodiments in which a chromium oxide layer serves as the cap layer of an IR reflective coating, the predominant metal cation in the sheet can be divalent. Accordingly, adhesion control agents in the formulation of the polymeric, for example, poly(vinyl butyral), sheet layer component of the invention in which a chromium oxide cap layer is used can be divalent metal salts of C₁ to C₈ organic, preferably aliphatic, monocarboxylic acids. Such acids can be straight chained or branched aliphatic. The divalent metal cation is preferably a member of Group II-A or II-B of the Periodic Table such as magnesium, calcium or zinc. Representative anions are acetate, butyrate, 2-ethylbutyrate, and octanoate. A minor amount of monovalent cation in the metal carboxylic salt formulation of embodiments using a chromium oxide cap layer can be present without adverse affect on adhesion to the chromium oxide layer. Such monovalent cation, typically sodium or potassium, is usually present in the poly(vinyl butyral) resin of the sheet as a byproduct of the process employed in synthesizing the resin. For example, sodium and potassium acetate may be present from acid neutralization in the poly(vinyl butyral) resin synthesis process.

In embodiments with a chromium oxide cap layer, the amount of carboxylic acid metal salt containing predominately divalent metal cation, and, if present, monovalent metal cation in minor amount in the sheet to provide the desired level of adhesion of the sheet to glass and chromium oxide, is determined by the titer of the sheet. Such titer, which includes titer attributed to that from the resin as well as to the divalent metal salt additive, can be, for example, from 20 to 120, or 30 to 110. The carboxylic acid metal salt additive can be incorporated into the sheet formulation by dispersing it in the plasticizer for the sheet.

Further embodiments of the present invention utilize the same polymeric layers having a low glass transition temperature, as detailed above, in contact with an infrared reflective layer disposed in contact with a substrate other than glass. Specifically, the infrared reflective layer can be in contact with a layer comprising any suitable polymer, for example, polyethylene terephthalate (PET) or polyethylene napthalate (PEN).

In these embodiments, a laminated glass panel comprises: a glass layer; a layer of poly(vinyl butyral) or other polymeric layer disposed in contact with said glass layer, wherein said layer of poly(vinyl butyral) or other polymeric layer has a glass transition temperature 23° C. or less; an infrared reflective layer disposed in contact with said layer of poly(vinyl butyral) or other polymeric layer; and, a layer of polyethylene terephthalate or polyethylene napthalate disposed in contact with said infrared reflective layer. Of course, further layers can be added to form a complete multiple layer glass panel, including, for example, layers of poly(vinyl butyral) and glass.

For embodiments comprising a layer of polyethylene terephthalate or polyethylene napthalate onto which an infrared reflective layer has been formed, the various layers of the laminated glass panel can be arranged in any suitable order. For example, a panel having layers of glass/poly(vinyl butyral)/infrared reflective layer/polyethylene terephthalate/poly(vinyl butyral)/glass can be formed. In any embodiments in which a layer of polyethylene terephthalate or polyethylene napthalate in contact with an infrared reflective layer is disposed between two polymeric layers of, for example, poly(vinyl butyral), the two polymeric layers need not have the same characteristics. In other words, the polymeric layer in contact with the infrared reflective layer will be any of the layers described herein as having a low glass transition temperature, while the second polymeric layer that is in contact with the polyethylene terephthalate or polyethylene napthalate can be any conventional polymeric layer, such as poly(vinyl butyral), or, alternatively can be any of the polymeric layers described herein as part of the present invention.

In order to measure the long term stability of any of the polymeric layer/infrared reflecting layer bonds of the present invention, an accelerated light exposure technique can be used. The long term strength of the cap layer/polymeric layer bond is measured by accelerated testing exposure of glass panel assembly to a source of intense UV radiation in the form of a Fadeometer (carbon arc source), Weatherometer (xenon arc source), EMMA testing or equivalent system (including a QUV system) in which a large percentage of the light emitted is composed of UV radiation. After exposure to UV radiation in one of the above-referenced systems, resistance of the bond to deterioration can be determined by the Pummel Adhesion Test, described elsewhere herein.

Exposure of the glass panel to UV light in the accelerated systems can be quantified in Langleys. In various embodiments of the present invention, the bond between the infrared reflective layer and the polymeric layer, after exposure to 200,000 Langleys, shows a degradation of less than 15%, less than 10%, less than 8%, less than 5%, less than 2.5%, or less than 1% as measured by change in Pummel. For example, a bond is said to exhibit a 5% degradation if pummel is reduced from a starting value of 6 to a final value of 5.7. Alternatively, in various embodiments of the present invention, the bond shows a decrease in pummel of 2 or less, 1 or less, or no change in pummel value after exposure to 200,000 Langleys.

In various embodiments of the present invention, the bond between the infrared reflective layer and the polymeric layer, after exposure to 500,000 Langleys, shows a degradation of less than 15%, less than 10%, less than 8%, less than 5%, less than 2.5%, or less than 1% as measured by change in Pummel. For example, a bond is said to exhibit a 5% degradation if pummel is reduced from a starting value of 6 to a final value of 5.7. Alternatively, in various embodiments of the present invention, the bond shows a decrease in pummel of 2 or less, 1 or less, or no change in pummel value after exposure to 500,000 Langleys.

Methods of the present invention include methods of making any of the laminated glass panels disclosed herein as within the scope of the present invention using any conventional techniques for assembling the panel, as discussed elsewhere herein.

The present invention also includes a method of reducing infrared electromagnetic radiation through an opening, comprising: disposing a panel of laminated glass in said opening, wherein said panel of laminated glass comprises: a glass layer; an infrared reflective layer disposed in contact with said glass layer; and, a polymer layer disposed in contact with said infrared reflective layer, wherein said polymer layer has a glass transition temperature of 23° C. or less. As used herein, an “opening” is any space through which light passes that can be fitted with a laminated glass panel of the present invention.

The present invention also includes a method of reducing infrared electromagnetic radiation through an opening, comprising: disposing a panel of laminated glass in said opening, wherein said panel of laminated glass comprises any of the laminated glass panels disclosed herein as within the scope of the present invention.

As used herein, “resin” refers to the polymeric (for example poly(vinyl butyral)) component that is removed from the mixture that results from the acid catalysis and subsequent neutralization of the polymeric precursors. Resin will generally have other components in addition to the polymer, for example poly(vinyl butyral), such as acetates, salts, and alcohols. As used herein, “melt” refers to a melted mixture of resin with a plasticizer and optionally other additives.

The polymer sheets of the present invention can comprise any suitable polymer, and, in a preferred embodiment, as exemplified above, the polymer sheet comprises poly(vinyl butyral). In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In another embodiment, the polymer sheet comprises a polymer selected from the group consisting of poly(vinyl butyral), polyurethane, poly(vinyl chloride), poly(ethylene vinyl acetate), combinations thereof, and the like. In one embodiment, the polymer sheet comprises poly(vinyl butyral). In other embodiments, the polymer sheet comprises plasticized poly(vinyl butyral). In further embodiments the polymer sheet comprises poly(vinyl butyral) and one or more other polymers. Other polymers having a suitable glass transition temperature can also be used. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful as components in polymer sheets.

For embodiments comprising poly(vinyl butyral), the poly(vinyl butyral) can be produced by known acetalization processes that involve reacting poly(vinyl alcohol) with butyraldehyde in the presence of an acid catalyst, followed by neutralization of the catalyst, separation, stabilization, and drying of the resin.

In various embodiments, the polymer sheet comprising poly(vinyl butyral) comprises 10 to 35 weight percent (wt. %) hydroxyl groups calculated as PVOH, 13 to 30 wt. % hydroxyl groups calculated as PVOH, or 15 to 22 wt. % hydroxyl groups calculated as PVOH. The polymer sheet can also comprise less than 15 wt. % residual ester groups, 13 wt. %, 11 wt. %, 9 wt. %, 7 wt. % , 5 wt. %, or less than 3 wt. % residual ester groups calculated as polyvinyl acetate, with the balance being an acetal, preferably butyraldehyde acetal, but optionally including other acetal groups in a minor amount, e.g., a 2-ethyl hexanal group (see, for example, U.S. Pat. No. 5,137,954).

In various embodiments, the polymer sheet comprises poly(vinyl butyral) having a molecular weight greater than 30,000, 40,000, 50,000, 55,000, 60,000, 65,000, 70,000, 120,000, 250,000, or greater than 350,000 grams per mole (g/mole or Daltons). Small quantities of a dialdehyde or trialdehyde can also be added during the acetalization step to increase molecular weight to greater than 350 g/m (see, for example, U.S. Pat. Nos. 4,902,464; 4,874,814; 4,814,529; 4,654,179) As used herein, the term “molecular weight” means the weight average molecular weight. Any suitable method can be used to produce the polymer sheets of the present invention. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3_{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

Additives may be incorporated into the polymer sheet to enhance its performance in a final product. Such additives include, but are not limited to, plasticizers, dyes, pigments, stabilizers (e.g., ultraviolet stabilizers), antioxidants, flame retardants, IR absorbers, anti-block agents, combinations of the foregoing additives, and the like, as are known in the art.

Additives that can be used for the purpose of preventing blocking between sheets of the polymers of the present invention (anti-blocking agents) include those conventional agents that are known in the art, and agents disclosed in the following patents or applications: German Publications DE10064373A1 and DE10162338 and International Publication WO0351974A1. In addition, anti-blocking agents that are disclosed in copending U.S. application Ser. Nos. 10/457,185; 10/427,412; 10/457,642; and 10/452,146 can also be used in combination with the polymer sheets of the present invention.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779, and C₆ to C₈ adipate esters, such as hexyl adipate.

The poly(vinyl butyral) or other polymer and plasticizer additives can be thermally processed and configured into sheet form according to methods known to those of ordinary skill in the art. One exemplary method of forming a poly(vinyl butyral) sheet comprises extruding molten poly(vinyl butyral) comprising resin, plasticizer, and additives (hereinafter “melt”) by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet. In either embodiment, the surface texture at either or both sides of the sheet may be controlled by adjusting the surfaces of the die opening or by providing texture at the roller surface. Other techniques for controlling the sheet texture include varying parameters of the materials (for example, the water content of the resin and/or the plasticizer, the melt temperature, molecular weight distribution of the poly(vinyl butyral), or combinations of the foregoing parameters). Furthermore, the sheet can be configured to include spaced projections that define a temporary surface irregularity to facilitate the de-airing of the sheet during lamination processes after which the elevated temperatures and pressures of the laminating process cause the projections to melt into the sheet, thereby resulting in a smooth finish. In various embodiments, the polymer sheets can have thicknesses of 0.1 to 2.5 millimeters, 0.2 to 2.0 millimeters, 0.25 to 1.75 millimeters, and 0.3 to 1.5 millimeters (mm).

Further, the present invention includes a laminated safety glass comprising a layer of glass, typically comprising silicon dioxide, disposed in contact with any of the IR reflecting layer/polymer sheet constructs of the present invention. Further included is a laminated safety glass comprising at two sheets of glass with a reflecting layer/polymer sheet construct of the resent invention disposed therebetween.

The present invention also includes windshields, windows, and other finished glass products comprising multiple layer contructs of the present invention.

Various polymer sheet and/or laminated glass characteristics and measuring techniques will now be described for use with the present invention.

The clarity of a polymer sheet, and particularly a poly(vinyl butyral) sheet, can be determined by measuring the haze value, which is a quantification of light not transmitted through the sheet. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)—Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17° C. (0° F.) and manually pummeled with a hammer to break the glass. All broken glass that is not adhered to the poly(vinyl butyral) sheet is then removed, and the amount of glass left adhered to the poly(vinyl butyral) sheet is visually compared with a set of standards. The standards correspond to a scale in which varying degrees of glass remain adhered to the poly(vinyl butyral) sheet. In particular, at a pummel standard of zero, no glass is left adhered to the poly(vinyl butyral) sheet. At a pummel standard of 10, 100% of the glass remains adhered to the poly(vinyl butyral) sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: Transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness.

As used herein, “titer” can be determined for sodium acetate and potassium acetate (as used herein, the “total alkaline titer”) and magnesium salts in a sheet sample using the following method.

In order to determine the amount of resin in each sheet sample that is weighed, the following equation is used, where PHR is defined as the pounds per hundred pounds of resin including plasticizer and any other additives to the resin in the original sheet sample preparation.

$$Grams of resin in sheet sample = \frac{Grams sheet sample}{( 100 + PHR ) / 100}$$

Approximately 5 g of resin in the sheet sample is the target mass used to estimate the amount of sheet sample to start with, with the calculated mass of resin in the sheet sample used for each titer deterrnination. All titrations should be completed in the same day.

The sheet sample is dissolved into 250 mls of methanol in a beaker. It may take up to 8 hours for the sheet sample to be completely dissolved. A blank with just methanol is also prepared in a beaker. The sample and blank are each titrated with 0.00500 normal HCl using an automated pH titrator programmed to stop at a pH of 2.5. The amount of HCl added to each the sample and the blank to obtain a pH of 4.2 is recorded. The HCl titer in terms of [mls 0.01N HCl/100 g resin] is determined according to the following:

$$HCl Titer = \frac{50 \times ( mls of HCl for sample - mls of HCl for blank )}{Calculated grams of resin}$$

To determine magnesium salt titer, the following procedure is used:

12 to 15 mls of pH 10.00 Buffer solution, prepared from 54 grams of ammonium chloride and 350. mls of ammonium hydroxide diluted to one liter with methanol, and 12 to 15 mls of Erichrome Black T indicator are added to the blank and each sheet sample, all of which have already been titrated with HCl, as described above. The titrant is then changed to a 0.000298 g/ml EDTA solution prepared from 0.3263 g tetrasodium ethylenediaminetetraacetate dihydrate, 5 ml water, diluted to one liter with methanol. The EDTA titration is measured by light transmittance at 596 nm. The % transmittance is first adjusted to 100% in the sample or blank before the titration is started while the solution is a bright magenta-pink color. When transmittance at 596 nm becomes constant, the EDTA titration is complete, and the solution will be a deep indigo color. The volume of EDTA titrated to achieve the indigo blue end point is recorded for the blank and each sheet sample. Magnesium salt titer is determined according to the following:

$$Magnesium Salt Titer [ as 1 \times {10}^{- 7} mole of magnesium salt per gram resin ] = \frac{\begin{matrix}0.000298 g \text{/} ml EDTA \times \\ ( mls of EDTA for sample - mls of EDTA for blank )\end{matrix}}{\begin{matrix}( grams of resin in sheet sample ) \times \\ 380.2 g \text{/} mole EDTA \times 0.0000001\end{matrix}}$$

From this result, total alkaline titer, as 1×10₋₇ mole of acetate salt per gram resin, can be calculated according to the following:
Total Alkaline Titer=HCl titer of sheet−(2×Total Magnesium Salt Titer)

### EXAMPLE 1

In this example, two laminated glass structures are formed. Each has four layers, in the following order: glass layer/infrared reflective layer/poly(vinyl butyral) layer/glass layer. In the first structure, the poly(vinyl butyral) has a glass transition temperature of 18° C. In the second structure, the poly(vinyl butyral) has a glass transition temperature of 30° C. The other three layers of the two structures are identical.

The two laminated glass structures are exposed to light to the extent shown in the table below. Pummel results for each glass layer for each structure are also shown.

| | Light | Pummel for glass | Pummel for glass |
|---|---|---|---|
| poly(vinyl | Exposure | layer in contact | layer in contact |
| butyral) | (measured as | with infrared | with poly(vinyl |
| layer | Langleys) | reflective layer | butyral) layer |
| Low T_{g} | 0 | 6.0 | 6.0 |
| | 250,000 | 5.0 | 5.0 |
| | 500,000 | 5.0 | 5.0 |
| Standard T_{g} | 0 | 5.0 | 7.5 |
| | 250,000 | 1.5 | 8.0 |
| | 500,000 | 1.5 | 6.5 |

As shown in the table above, pummel values for the laminated glass using poly(vinyl butyral) with a standard glass transition temperature will result in lower pummel results after exposure to 250,000 Langleys, which is equivalent to over one year's light exposure, while the panels incorporating a low glass transition temperature poly(vinyl butyral) layer will maintain high pummel values.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

It will further be understood that any of the ranges, values, or characteristics given for any single component of the present invention can be used interchangeable with any ranges, values, or characteristics given for any of the other components of the invention, where compatible, to form an embodiment having defined values for each of the components, as given herein throughout. For example a laminated glass panel can be formed in multiple permutations, comprising poly(vinyl butyral) having plasticizer in any of the ranges given that will result in the proper T_{g} in addition to any type of infrared reflective layer given.

It will further be understood that, where given, ranges and values are exemplary, and, unless otherwise noted, do not suggest or mean that other ranges and values cannot be used.

Each reference, including journal articles, patents, applications, and books, referred to herein, is hereby incorporated by reference in its entirety.

1. A laminated glass panel, comprising:
a glass layer;
an infrared reflective layer disposed in contact with said glass layer; and,
a polymer layer disposed in contact with said infrared reflective layer, wherein said polymer layer has a glass transition temperature of 23° C. or less.

2. The glass panel of claim 1, wherein said infrared reflective layer comprises a metal oxide layer and a silver layer.

3. The glass panel of claim 1, wherein said infrared reflective layer comprises a cap layer of CrₓO_{y} where x is less than or equal to 2 and y is less than or equal to 5.

4. The glass panel of claim 1, wherein said glass transition temperature is less than 21° C.

5. The glass panel of claim 1, wherein said glass transition temperature is less than 20° C.

6. The glass panel of claim 1, wherein said glass transition temperature is less than 18° C.

7. The glass panel of claim 1, wherein said glass transition temperature is less than 15° C.

8. The glass panel of claim 1, wherein said polymer layer comprises poly(vinyl butyral).

9. The glass panel of claim 8, wherein said polymer layer comprises a plasticizer.

10. The glass panel of claim 9, wherein said plasticizer is present in said polymer layer in at least 40 parts per hundred.

11. The glass panel of claim 9, wherein said plasticizer is present in said polymer layer in at least 50 parts per hundred.

12. The glass panel of claim 1, further comprising a second layer of glass disposed in contact with said polymer layer.

13. The glass panel of claim 1, wherein said polymer layer further comprises an agent selected from the group consisting of adhesion control agents, pigments, dyes, stabilizers, flame retardants, anti-oxidents, anti-block agents, and solar absorbers.

14. A laminated glass panel, comprising:
a first glass layer;
an infrared reflective layer disposed in contact with said first glass layer;
a polymer layer disposed in contact with said infrared reflective layer, wherein said polymer layer comprises poly(vinyl butyral) and has a glass transition temperature of 23° C. or less; and,
a second glass layer disposed in contact with said polymer layer.

15. The glass panel of claim 14, wherein said glass transition temperature is less than 20° C.

16. The glass panel of claim 14, wherein said glass transition temperature is less than 18° C.

17. The glass panel of claim 14, wherein said glass transition temperature is less than 15° C.

18. The glass panel of claim 14, wherein said polymer layer comprises a plasticizer in at least 40 parts per hundred.

19. The glass panel of claim 14, wherein said polymer layer comprises a plasticizer in at least fifty parts per hundred.

20. A method of reducing infrared electromagnetic radiation through an opening, comprising:
disposing a panel of laminated glass in said opening, wherein said panel of laminated glass comprises:
a glass layer;
an infrared reflective layer disposed in contact with said glass layer; and,
a polymer layer disposed in contact with said infrared reflective layer, wherein said polymer layer has a glass transition temperature of 23° C. or less.

21. A laminated glass panel, comprising:
a glass layer;
a layer of poly(vinyl butyral) disposed in contact with said glass layer, wherein said layer of poly(vinyl butyral) has a glass transition temperature of 23° C. or less;
an infrared reflective layer disposed in contact with said layer of poly(vinyl butyral); and,
a layer of polyethylene terephthalate or polyethylene napthalate disposed in contact with said infrared reflective layer.
